(19) United States
(12) Patent Application Publication
(10) Pub. No.: US 2020/0005792 A1
(43) Pub. Date: Jan. 2, 2020

(54) Novel and innovative means of providing an anonymized and secure mechanism for speech-to-text conversion. This invention provides a versatile and extensible privacy layer that leverages existing cloud-based Automated Speech Recognition (ASR) services and can accommodate emerging speech-to-text technologies, such as Natural Language Processing (NLP), voice bots and other voice-based artificial intelligence interfaces. This invention also allows the latest and best-of-breed speech technologies to be applied to the legal, medical, financial, and other privacy-sensitive fields without sacrificing

(71) Applicant: Ralph T. Wutscher, Chicago, IL (US)

(72) Inventor: Ralph T. Wutscher, Chicago, IL (US)

(21) Appl. No.: 16/456,914

(22) Filed: Jun. 28, 2019

Related U.S. Application Data
(60) Provisional application No. 62/763,682, filed on Jun. 28, 2018.

(51) Int. Cl. G10L 15/30; G10L 15/22; G10L 15/18; G10L 15/02; H04L 29/06

(52) U.S. Cl. CPC G10L 15/30; G10L 15/22; H04L 63/0457; G10L 15/02; G10L 15/1822

(57) ABSTRACT

Novel and innovative means of providing an anonymized and secure mechanism for speech-to-text conversion. This invention provides a versatile and extensible privacy layer that leverages existing cloud-based Automated Speech Recognition (ASR) services and can accommodate emerging speech-to-text technologies, such as Natural Language Processing (NLP), voice bots and other voice-based artificial intelligence interfaces. This invention also allows the latest and best-of-breed speech technologies to be applied to the legal, medical, financial, and other privacy-sensitive fields without sacrificing security and privacy.

### RELATED APPLICATIONS

This application claims priority from Provisional Application No. 62/763,682.

### FIELD OF THE INVENTION

This invention is called Legistee. It relates to the translation of spoken words to text. However, rather than relying on a bespoke speech-to-text technology, Legistee leverages publicly available and ever-advancing Automated Speech Recognition (ASR) services—both cloud based (e.g. Google, Apple, Amazon, IBM, etc.) as well as privately hosted ASR systems.

The first part of this invention is the use of multiple ASRs in one system, such that no single ASR receives or converts all of the speech processed by the system. Legistee can be configured using a rules-based approach to add, remove, and use various different ASRs as needed. This allows any ASR that provides an Application Layer Interface (API) to be integrated. Optionally, a simple abstraction interface is provided to flexibly adapt Legistee to new ASRs that may not provide an API.

The second part of this invention is a stream router. The stream router provides the mechanism for the use of multiple ASRs in one system, and provides security and anonymity.

Speech is converted into data and streamed to Legistee. As the speech data is streamed from a user to Legistee, the invention uses various characteristics of the speech to divide the speech into distinct fragments. For example, and without limitation, one such characteristic is silence detection for natural language pauses, by which natural language is divided into fragments between the pauses. Other grammatical signifiers may alternatively be used to divide the speech into segments.

The length between the characteristic division points—such as pauses, or other grammatical signifiers—is configurable with a global or rules-engine based approach. The division points are used to segment the incoming speech data stream and route the segments various separate ASRs.

By using the various ASRs with a common Legistee identity signature and sending each ASR only a segmented portion of each stream, Legistee provides anonymity and obfuscation, and therefore, privacy of confidential and sensitive speech data.

In addition, all incoming/outgoing voice streams and text streams to and from the various ASRs are encrypted to further improve security. If any of the ASRs become compromised, Legistee acts as a failover system by preventing any single ASR's data from being reconstructed. This is because any single ASR's speech or text data is an incomplete portion of the original stream and has no context because the origin user of Legistee remains unknown to the ASRs.

These routing functions can further be used to adjust the mix of ASRs to balance and improve performance. Rules can be defined to consider metrics as requests are processed to maintain overall performance and security of the Legistee system.

The third part of the Legistee system is the syntactical parsing and processing of trigger (key) words. The rules engine can be configured to accommodate the natural speech patterns for the user.

For example, and without limitation, in the context of sensitive and confidential legal billing, the spoken phrase “OK Legistee, bill 0.7 hours to Smith/ACME for drafting motion to dismiss” is converted into speech data, the speech data is segmented on silence detection, each segment of speech data is routed securely and anonymously to the various distinct ASRs. Then, the collected text data returned from the ASRs is analyzed and used to create the legal billing entry in text form.

Therefore, the voice stream would result as:
Trigger to initiate a Legistee processing: “OK Legistee”
Create a new Legal Bill: “Bill 0.7 hours”
Set type of Legal Bill to Time Entry: “0.7 hours”
Set Value of Entry: “0.7 hours”
Set Client for Billing Entry: “to Smith”
Set Matter for Billing Entry: “ACME”
Set Description of Billing Entry: “for drafting a motion to dismiss”

Based on configurable rules, each entry can be earmarked for further review depending on any comprehension or any other kind of metrics returned by the ASRs that provide such data.

The fourth part of Legistee is the novel API/abstraction interface. This provides the core Legistee engine with a consistent yet extensible way to support current and future ASRs. The interface can also be customized to leverage specific features of ASRs—to training for responses, weighted candidate responses, quality/confidence metrics, and similar features.

Batch processing is the fifth feature of Legistee. For maximum accuracy or simply to defer processing, the input voice streams can be queued and processed by the Legistee engine as a deferred process. In this way, users wishing greater speech conversion accuracy, or wanting to simply process recorded voice dictations, or any other post processing scenario can be supported.

Sixth, although the above example relates to sensitive and confidential legal billing, because of the highly configurable and modular nature of the Legistee engine and its constituent processing components, a wide variety of applications outside of the legal industry are supported. For example, and without limitation, this invention will also be manifested in speech-to-text conversion, voice recognition, voice bots, and other voice-based applications in the medical, financial services, and other privacy-sensitive fields without sacrificing security and privacy.

The seventh feature of Legistee is the Business Rules Engine. This workflow feature allows Legistee to scale from a very simple to set-up and use system, all the way to advanced decision-based processing platform. The Business Rules Engine itself is modular. This allows it to be used in various aspects of Legistee processing as noted above, and as more advanced Rules Engines become available (beyond Inference, Event Condition Action, and similar), they can be modularly adapted to the Legistee system.

Legistee accomplishes all the goals of privacy and security in speech to text conversion through a novel and innovative method that is both highly secure, confidential via segmentation/anonymization, and relatively easy to implement, yet offers powerful capabilities via modular extensibility.

### BACKGROUND OF THE INVENTION

The following is excerpted from an article by Christopher Riordan of Incubator LLC, a software development company headquartered in Chicago, Ill., and an affiliate of EffortlessLegal LLC, a leader in software automation solutions for law firms. The article as first published in the American Bar Association's Law Technology Today publication on Feb. 27, 2018.

Digital voice assistants are transforming the way businesses in general operate, making daily tasks as easy as a simple voice command. Digital assistants like Amazon's Alexa, Apple's Siri, Microsoft's Cortana, and Google Voice are now being deployed in law firms as well. Scheduling appointments, getting answers to questions, conducting research, billing, and other mundane tasks may now be handled by voice using a desktop computer, smartphone, or one of several Internet of Things (IoT) devices.

Law firms present a significant hurdle for digital assistants—i.e., the requirement of strict confidentiality.

ABA Model Rule 1.6(a) protects the confidentiality of all “information relating to the representation of a client,” subject to certain exceptions, such that the disclosure of such information is only authorized if the client provides informed consent. According to the American Bar Association, as of Sep. 29, 2017, every state has adopted some form of confidentiality requirement for attorneys.

In addition, ABA Model Rule 1.6(c) requires that an attorney must “make reasonable efforts to prevent the inadvertent or unauthorized disclosure of, or unauthorized access to, information relating to the representation of a client.”

In the context of internet communications, the American Bar Association's Standing Committee on Ethics and Professional Responsibility recently concluded that “a lawyer may be required to take special security precautions to protect against the inadvertent or unauthorized disclosure of client information when required by an agreement with the client or by law, or when the nature of the information requires a higher degree of security.”

Among other things, ABA Formal Opinion 477R recommends that “[a] lawyer should understand how their firm's electronic communications are created, where client data resides, and what avenues exist to access that information.” According to at least one commenter, “[t]his unfortunately means reading those EULA agreements [End User License Agreement] we all click past without a second thought.”

A lawyer's confidentiality obligations can be separated into two categories: 1) preventing third-party disclosure; and 2) keeping client information secure from unauthorized access.

The issue of avoiding third-party disclosure of confidential client information is a significant concern. When a digital assistant is used, everything that is being said gets sent over the internet to the digital assistant host company for processing, where the user's speech is often analyzed and stored in order that the host company can improve its digital assistant.

The issue of third-party disclosure is well-established for various types of voice-to-text when the transcription feature processes the voice into text on remote servers. The same privacy concerns apply to digital assistants.

Moreover, most digital assistants, as well as IoT products such as Amazon Echo or Google

Home, for example, require a trigger or “wake” word that fires them up to be able to respond to a question or command. That means the microphone must remain on in order to listen for the trigger word, potentially listening in on everything a lawyer is saying.

If a voice assistant or its host company is listening in on a lawyer talking about a case with their client, perhaps because the lawyer has a digital assistant device sitting on the desk in his or her office, the lawyer could potentially be violating the lawyer's home state's analogue to ABA Rule 1.6, or even compromising the attorney-client privilege due to third-party disclosure.

Security is also a concern because some digital assistants cannot distinguish one user from another. In her article “Amazon Echo Is Both Useful and Risky For Lawyers,” author Anna Massoglia says, “This means anyone within talking distance has access to every single account you've linked” to the digital assistant.

However, both Amazon's Echo and Google Home recently added support for multiple users, allowing their devices to respond differently based on the user's voice. This feature could presumably be deployed to limit unauthorized access to client information.

Security nevertheless remains a concern for a different reason, i.e., many digital assistant services store the attorney's voice data, whether for improving the quality of the service or otherwise. Recent years have seen several news reports of data breaches at numerous high profile and reputable companies, and even of government agencies, including at Yahoo,

Equifax, Target, Verizon, Uber, and the U.S. Securities and Exchange Commission. If a data breach occurs while an attorney's confidential speech data is stored with the victim company, the confidential data could be compromised.

Therefore, as great as it is to have a digital assistant to help you get things done, their use can pose an issue with lawyers when it comes to confidentiality, and a lawyer's related obligations under Rule 1.6.

Generally, attorneys can still use voice recognition services for their billing. For example, Microsoft's Speech Recognition app, Apple's Enhance Dictation feature, and Nuance's Dragon Legal software all appear to conduct their voice-to-text processing without sending any speech data to offsite processing services for conversion into text. Accordingly, these solutions should offer sufficient privacy and security to meet an attorney's obligations under Rule 1.6.

Microsoft has long offered a speech recognition service built into its Windows operating systems. Similarly, Apple offers an enhanced dictation feature that will convert speech to text on your computer without processing it on Apple's servers. These features should allow you to enter time into your billing system by voice from your desktop computer.

In addition, if you can access your billing system via a smartphone browser, Apple phones allow an offline dictation feature, meaning the conversion of voice to text is done on the phone and without sending information to Apple's servers. Likewise, Google's Android smartphones have an offline voice recognition feature that can be used for the same purpose.

Nuance's Dragon Legal software is another inviting alternative. This software provides speech recognition capabilities that are tailored to legal terms. Because the software is locally installed, the attorney has greater control over all privacy and security concerns relating to maintaining the confidentiality of speech data provided to the app.

Nuance's Dragon Anywhere Group also provides a web-based platform for mobile users, including via iOS and Android smartphone apps. However, use of Dragon Anywhere Group service requires sending the attorney's speech data to Nuance's servers for processing. Nuance's Privacy Policy states that, “We may use the information that we collect for our internal purposes to develop, tune, enhance and improve our products and services and for advertising and marketing consistent with this Privacy Policy.”

More recently released digital billing assistant apps might also be appealing. For example, Three Matts' legal voice assistant, “Tali,” uses Amazon's Echo or other Alexa-powered products to track and record time entries. The app allows an attorney to ask Alexa to “tell Tali,” and then state the task the attorney is working on. Alexa will relay the command over to Tali. The digital billing assistant will then keep track of time until the attorney tells Tali they are finished or to start a new task. Tali can also email the attorney a description of all the things the attorney tracked using the app, and the amount of time spent.

Similarly, Workspace Assistant by Thomson Reuters “allows the input of time entry and the querying of time statistics via Alexa and connects with the broader Thomson Reuters Workspace and Elite 3E system.” Like Tali, the Workspace Assistant app runs on Amazon Alexa-enabled devices and records time entries. When the attorney using the Workspace Assistant app finishes keeping time, Alexa asks if the attorney is finished and sees what matter should be billed for the task. Because Workspace Assistant is compatible with any Alexa-enabled device, it is practical on mobile as well.

However, because both Tali and Workplace Assistant use Amazon's Alexa service for speech recognition, both apps are subject to Amazon's terms of use and privacy policy as to their speech recognition functions.

The Alexa Terms of Use state: “Alexa streams audio to the cloud when you interact with Alexa. Amazon processes and retains your Alexa Interactions, such as your voice inputs, music playlists, and your Alexa to-do and shopping lists, in the cloud to provide and improve our services.” In addition, the Alexa Terms of Use provide, “Amazon processes and retains your Alexa Interactions and related information in the cloud in order to respond to your requests (e.g., ‘Send a message to Mom’), to provide additional functionality (e.g., speech to text transcription and vice versa), and to improve our services. We also store your messages in the cloud so that they're available on your Alexa App and select Alexa Enabled Products.”

As discussed above, because Amazon has the right to process and use the speech data an attorney sends to it, there are potential third-party disclosure concerns. Moreover, because Amazon has the right to retain the speech data, there are also security risks including possible data breach. Attorneys who might use Alexa or Alexa-enabled apps should, therefore, keep in mind the privacy and security risks relating to their confidentiality obligations under Rule 1.6.
Technology is changing, and if law firms are going to also improve their efficiency, implementing automated solutions will keep attorneys up to date and on top of their work. Machine learning, AI, and IoT are here to help out, providing more time for more billable hours.
However, attorney ethical requirements create interesting challenges for digital billing assistants, and for the attorneys who might want to use them. Of particular importance is an attorney's obligation to understand where and how his or her client's confidential data is being stored and used.

Like the legal industry, the medical and financial industries also have significant privacy, confidentiality, and information security restrictions. In the same way as in the legal services context, voice-related applications must account for the similar restrictions in the medical and financial services industries.

### SUMMARY OF THE INVENTION

The method and the system of this invention center around the innovative concepts of providing:
1. A novel and innovative mechanism and method for securely and privately leveraging best-of-breed speech-to-text services (ASRs) while maintaining the confidentiality of the requestor and their data.
2. A novel and innovative mechanism and method for converting speech-to-text that is both versatile as to how it can be deployed in websites and other internet applications, and easily extensible with respect to the integration with emerging ASR technologies.
3. A novel and innovative mechanism and method for securely and reliably collecting voice data (as streams or files), and segmenting the original, and using an unrelated identification and obfuscation to prevent exploitation by the service providers and/or hackers.
4. A novel and innovative mechanism and method for providing a configurable set of cloud-based and privately hosted ASRs to provide speech-to-text capability to any systems that have a secured Application Programming Interface (API).
5. A novel and innovative mechanism and method for providing a comprehensive rules-based workflow engine to configure: how inputs are processed, determine quality of the processing, handling of exceptions, and how and which ASRs are used. These rules also allow attaching and/or retrieving any additional meta-data which can be further used to process additional workflows.
6. Secure storage and implementation of the business rules and any inputs/output of the Legistee system.
7. A method of securely and selectively integrating the Legistee system with existing web-facing applications and architectures.
8. An easy to use method of adding new cloud-based ASRs and other voice-based systems as they become available with workflow control.
9. A modular architecture to enhance/extend the core functions of the Legistee system.
10. A facility for reporting and analyzing requests and results. This administration tool will allow monitoring, configuration, and review of all processed/unprocessed entries in the system and their outcomes.
11. Manual over-ride of automated speech-to-text conversions with the ability to add meta-data to help ASRs and other voice-based systems to avoid future exceptions.

### BRIEF DESCRIPTION OF DRAWING

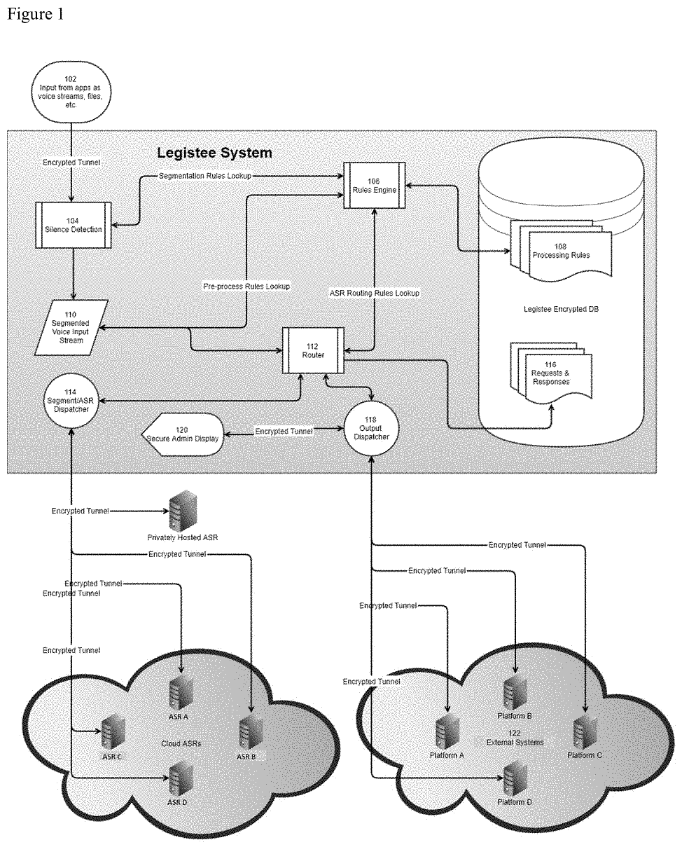

Referencing FIG. 1:

102. The Legistee system receives voice input as a stream or file via a secured encrypted tunnel.

104. As each stream is received, the Rules Engine (106) is consulted for instructions on how to segment the entry based on silence detection as configured in the Processing Rules (108).

106. The Rules Engine uses the Processing Rules (108) as part of the workflow to determine:
A. Configured parameters for segmenting the voice stream
B. Which ASRs to route stream segments to
C. Configured additional parameters to send to ASRs
D. Configured metrics to collect from ASRs
E. Configured thresholds and other meta-data for subsequent post-processing of results from ASRs
F. Assembly of results from ASRs for return to requestor
G. Monitoring of each ASR used to measure performance and configurable for any other returned metrics
H. Which External Systems (122) to send the resulting entries to.
I. Configured additional parameters to send to external systems.
J. Configured metrics to collect from external systems.
K. Assembly of results from external systems to return to requestor for reporting purposes.
L. Monitoring of each external system used to measure performance and configurable for any other returned metrics

108. The processing rules are secured with encryption in the Legistee system. This module is flexible and extensible to allow for the use of any open and closed source business rules engine that is required.

110. After the voice input is segmented, it is passed to next pre-ASR processing stage. Here additional rules may be applied (e.g. transcoding to other audio formats, etc.) Any other required pre-ASR process may also be configured and applied in this step.

112. Next the pre-processed and segmented streams arrive at the router. After the voice segments are received, the router the Rules Engine (106) is used again to determine:
A. Which ASRs are to be used
B. What set of additional parameters/data is to be sent to the ASR (along with the voice stream segment)
C. The Legistee Identification credentials for the ASR (to anonymize the request)
D. In addition to the standard ASR response, any additional meta-data to be requested to support ASR-specific functionality
E. Any post-processing exception handling rules based on any of the data returned from the ASR (e.g. if response is below a configured quality threshold, re-send request to another configured ASR, etc.)

The router will then securely send the segmented requests along with credentials, additional parameters (if any) to the Segment/ASR Dispatcher (114). Once the responses are received back to the router, they may be stored in the Legistee Encrypted DB (116). From here, additional processing, human review, or transmission to external systems can be performed. Again, the Rules Engine (106) can be utilized as part of any additional processing.

If a workflow has been configured, the results of the speech-to-text process can be securely transmitted to an Administration Display (120) and/or to External Systems (122) via secured Tunnels.

114. This part of the Legistee system asynchronously tracks the requests transmitted and its corresponding response, then returns the results back to the Router (112). As the Segment/Dispatcher uses Legistee identity credentials and communicates with all outside services using an encrypted channel, the security and anonymity of the original data is maintained. As explained earlier, no one ASR is sent enough data to reconstruct the original request even if the ASRs own security measures are compromised. If a secure channel (for any reason) cannot be established, the request is never sent, and an exception is recorded by the Segment/ASR Dispatcher and returned to the Router (112) for further processing if so configured.

118. Legistee also implements and Output Dispatcher. The feature (depending on the configuration of the Rules Engine (106 and 108), will route system output to an Administration Display (120) or External Systems (122).

120. The Administration Display facilitates both users of the Legistee application and the System Operators. This utility provides many functions including (but not limited to): Monitoring overall status, configuring the Rules Engine (106), viewing reports of completed and pending requests, handling exceptions, etc.

122. After processing of the Legistee system is completed, the Output Dispatcher (118) can (if so configured) send data over encrypted tunnels to external systems using their APIs. The configured Rules Engine (106) can also direct the Output Dispatcher (118) to retrieve any other additional meta-data and metrics during the transaction. All additional meta-data retrieved in this way can be further used by the Rules Engine (106) to for further workflow refinements.

The invention claimed is:

1. A mechanism and method for securely and privately leveraging best-of-breed Automated Speech Recognition (ASR) services while maintaining the confidentiality of the requestor and their data, comprising:
Interfacing with publicly available ASR services as selected and determined by the user through a rules-based approach through the ASR services' existing Application Layer Interface (API) or by use of a simple abstraction interface where the ASR does not provide an API;
Securely and reliably collecting voice data as streams or files;
Deconstructing the speech data into distinct fragments;
Using unrelated identification and obfuscation to prevent exploitation by the ASR service providers and/or hackers;
Using an encrypted stream router to convey the distinct speech data fragments obtained from the user to multiple ASR with each ASR receiving only a portion of the distinct speech data;
Receiving the results from the ASR following each respective ASR's processing of the distinct speech data fragments provided;
Analyzing the data received from the ASRs and applying configurable syntax rules to parse and process the speech data;
Applying the processed speech data to trigger pre-determined events or entries as specified by the user; and
Allowing the user to designate and prioritize speech input streams.

2. A computer system implementing the mechanism and method in claim 1, comprising:
A computer readable medium for the storing and processing of computer code;
Computer code for securely storing and retrieving data entries stored on a computer readable medium;
Computer code for a user interface and an application program interface (API);
Computer code for deconstructing speech into distinct data points;
Computer code for encrypting data points and for transmitting and receiving deconstructed speech data to separate ASRs;
Computer code for the analysis, parsing, organization, and assembly of text data received from ASRs;
Computer code for the graphical display of the processed speech data through the API; and
Computer code for adding or removing cloud-based ASRs and other voice-based systems in a modular fashion with workflow control.

3. The system described in claim No. 2, with access to the API through any internet-connected device, such as a desktop computer or portable or mobile device.
